(19) United States
(12) Patent Application Publication
(10) Pub. No.: US 2014/0148213 A1
(43) Pub. Date: May 29, 2014

(54) RANGE TUNING FOR OPEN ACCESS SMALL CELLS

(71) Applicant: QUALCOMM Incorporated, San Diego, CA (US)

(72) Inventors: Peerapol TINNAKORNSRISUPHAP, San Diego, CA (US); Mehmet YAVUZ, San Diego, CA (US); Damanjit SINGH, San Diego, CA (US); Rajat PRAKASH, San Diego, CA (US)

(73) Assignee: QUALCOMM Incorporated, San Diego, CA (US)

(21) Appl. No.: 14/171,457

(22) Filed: Feb. 3, 2014

Related U.S. Application Data
(63) Continuation-in-part of application No. 13/451,427, filed on Apr. 19, 2012.
(60) Provisional application No. 61/477,498, filed on Apr. 20, 2011.

(51) Int. Cl. H04W 16/18; H04W 52/28

(52) U.S. Cl. CPC H04W 16/18; H04W 52/28
USPC 455/522

(57) ABSTRACT

Range tuning for open access small cells may be achieved, for example, by determining a likelihood of handoff for a mobile device around a small cell coverage area, and adjusting a range of the small cell coverage area by controlling a transmit power level of the small cell based on the likelihood of handoff.

### CLAIM OF PRIORITY UNDER 35 U.S.C. §119

The present application is a continuation-in-part of U.S. application Ser. No. 13/451,427 filed on Apr. 19, 2012, which claims benefit of priority to Provisional Application No. 61/477,498 filed on Apr. 20, 2011, both of which are assigned to the assignee hereof and hereby expressly incorporated by reference herein.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of another telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology.

As the demand for mobile broadband access continues to increase, there exists a need for further improvements in base station coverage. One avenue that is currently under development is the use of smaller cells to extend the coverage area or otherwise work in conjunction with larger, macro cells. However, there remains a need in the art for improved systems and methods relating to small cell deployment.

### SUMMARY

Exemplary embodiments of the invention are directed to systems and method for range tuning for open access small cells. In one aspect, the method may for example include determining a likelihood of handoff for a mobile device around a small cell coverage area; and adjusting a range of the small cell coverage area by controlling a transmit power level of the small cell based on the likelihood of handoff.

In one aspect, the likelihood of handoff may be determined based on a number of ping-pong handoffs between adjacent cells.

In another aspect, the likelihood of handoff may be determined based on a ratio of ping-pong handoffs to non-ping-pong handoffs between adjacent cells.

In another aspect, the likelihood of handoff may be determined based on the time spent by a mobile device on the cell.

In another aspect, the likelihood of handoff may be determined based on the number of mobile devices served by the cell.

In another aspect, the likelihood of handoff may be determined based on a number of connection failures in the cell.

In another aspect, the likelihood of handoff may be determined based on interference experienced by at least one mobile device at the cell.

In another aspect, the likelihood of handoff may be determined based on at least one of a Signal-to-Interference-Ratio (SIR) of the cell and Signal-to-Interference-plus-Noise Ratio (SINR) of the cell.

In another aspect, an example apparatus for range tuning for open access small cells may include at least one processor configured to determine a likelihood of handoff for a mobile device around a small cell coverage area, and to adjust a range of the small cell coverage area by controlling a transmit power level of the small cell based on the likelihood of handoff. The apparatus may further include a memory coupled to the at least one processor and configured to store related data and/or instructions.

In another aspect, an example non-transitory computer-readable medium comprising code, which, when executed by at least one processor, causes the at least one processor to perform operations for range tuning for open access small cells. The non-transitory computer-readable medium includes code for determining a likelihood of handoff for a mobile device around a small cell coverage area, and code for adjusting a range of the small cell coverage area by controlling a transmit power level of the small cell based on the likelihood of handoff.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example of a two terminal system, for example, an access node/user equipment system.

FIG. 2 illustrates an example of a wireless communications system that supports a plurality of user devices.

FIG. 3 illustrates an example communication system in which small cells are deployed in concert with macro cells.

FIG. 4 illustrates an example method of range tuning for open access small cells.

FIG. 5 illustrates an example small cell base station apparatus configured to perform range tuning according to one or more of the embodiments described herein.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, or mode of operation, and alternate embodiments may be devised without departing from the scope of the invention. Additionally, well-known elements of the invention may not be described in detail or may be omitted so as not to obscure other, more relevant details.

While for purposes of simplicity of explanation, methodologies may be shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). Cdma2000 is described in documents from an organization named “3rd Generation Partnership Project 2” (3GPP2). These various radio technologies and standards are known in the art.

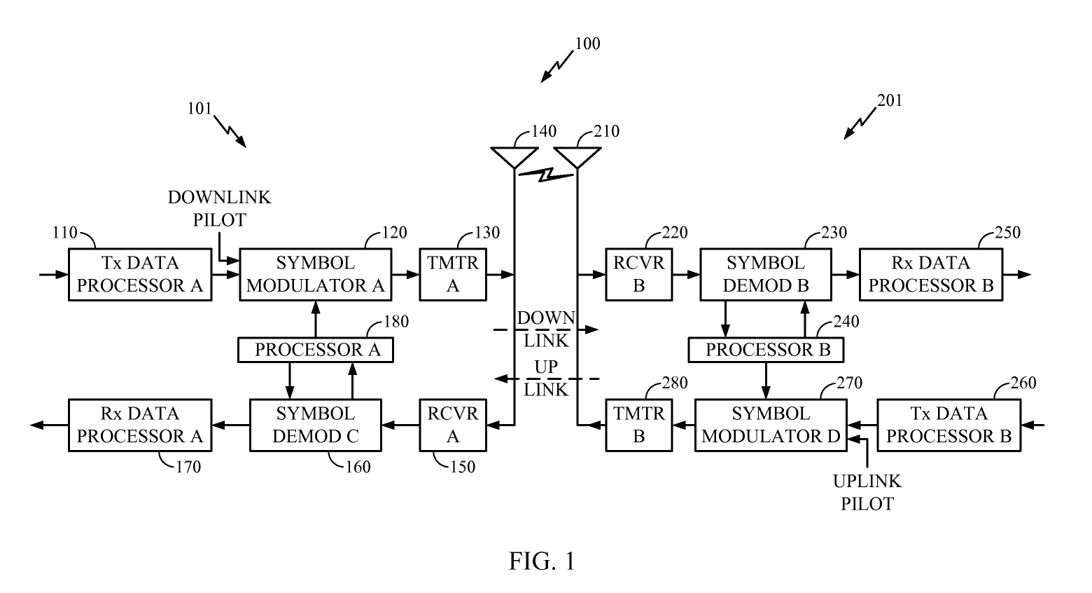

FIG. 1 is a block diagram illustrating an example of a two terminal system, for example, an access node/user equipment (UE) system 100. One skilled in the art will understand that the example access node/UE system 100 illustrated in FIG. 1 may be implemented in an FDMA environment, an OFDMA environment, a CDMA environment, a WCDMA environment, a TDMA environment, an SDMA environment or any other suitable wireless environment.

The access node/UE system 100 includes an access node 101 (e.g., base station or NodeB) and a UE 201 (e.g., handset or wireless communication device). In the downlink leg, the access node 101 includes a transmit (TX) data processor A 110 that accepts, formats, codes, interleaves and modulates (or symbol maps) traffic data and provides modulation symbols (e.g., data symbols). The TX data processor A 110 is in communication with a symbol modulator A 120. The symbol modulator A 120 accepts and processes the data symbols and downlink pilot symbols and provides a stream of symbols. The symbol modulator A 120 modulates (or symbol maps) traffic data and provides modulation symbols (e.g., data symbols). The symbol modulator A 120 is in communication with processor A 180, which provides configuration information. The symbol modulator A 120 is in communication with a transmitter unit (TMTR) A 130. The symbol modulator A 120 multiplexes the data symbols and downlink pilot symbols and provides them to the transmitter unit A 130.

Each symbol to be transmitted may be a data symbol, a downlink pilot symbol or a signal value of zero. The downlink pilot symbols may be sent continuously in each symbol period. The downlink pilot symbols may be, for example, frequency division multiplexed (FDM), orthogonal frequency division multiplexed (OFDM), code division multiplexed (CDM), etc. The transmitter unit A 130 receives and converts the stream of symbols into one or more analog signals and further conditions, for example, amplifies, filters and/or frequency upconverts the analog signals, to generate an analog downlink signal suitable for wireless transmission. The analog downlink signal is then transmitted through antenna 140.

In the downlink leg, the UE 201 includes antenna 210 for receiving the analog downlink signal and inputting the analog downlink signal to a receiver unit (RCVR) B 220. The receiver unit B 220 conditions, for example, filters, amplifies, and frequency downconverts the analog downlink signal to produce a first “conditioned” signal. The first “conditioned” signal is then sampled. The receiver unit B 220 is in communication with a symbol demodulator B 230. The symbol demodulator B 230 demodulates the first “conditioned” and “sampled” signal (e.g., data symbols) outputted from the receiver unit B 220. One skilled in the art will understand that an alternative is to implement the sampling process in the symbol demodulator B 230. The symbol demodulator B 230 is in communication with a processor B 240. Processor B 240 receives downlink pilot symbols from symbol demodulator B 230 and performs channel estimation on the downlink pilot symbols. Channel estimation involves the process of characterizing the current propagation environment. The symbol demodulator B 230 receives a frequency response estimate for the downlink leg from processor B 240. The symbol demodulator B 230 performs data demodulation on the data symbols to obtain data symbol estimates on the downlink path. The data symbol estimates on the downlink path are estimates of the data symbols that were transmitted. The symbol demodulator B 230 is also in communication with a receive (RX) data processor B 250.

The RX data processor B 250 receives the data symbol estimates on the downlink path from the symbol demodulator B 230 and, for example, demodulates (i.e., symbol demaps), deinterleaves and/or decodes the data symbol estimates on the downlink path to recover the traffic data. The processing by the symbol demodulator B 230 and the RX data processor B 250 is complementary to the processing by the symbol modulator A 120 and TX data processor A 110, respectively.

In the uplink leg, the UE 201 includes a TX data processor B 260. The TX data processor B 260 accepts and processes traffic data to output data symbols. The TX data processor B 260 is in communication with a symbol modulator D 270. The symbol modulator D 270 accepts and multiplexes the data symbols with uplink pilot symbols, performs modulation and provides a stream of symbols. Symbol modulator D 270 is in communication with processor B 240, which provides configuration information. The symbol modulator D 270 is in communication with a transmitter unit (TMTR) B 280.

Each symbol to be transmitted may be a data symbol, an uplink pilot symbol or a signal value of zero. The uplink pilot symbols may be sent continuously in each symbol period. The uplink pilot symbols may be, for example, frequency division multiplexed (FDM), orthogonal frequency division multiplexed (OFDM), code division multiplexed (CDM), etc. The transmitter unit B 280 receives and converts the stream of symbols into one or more analog signals and further conditions, for example, amplifies, filters and/or frequency upconverts the analog signals, to generate an analog uplink signal suitable for wireless transmission. The analog uplink signal is then transmitted through antenna 210.

The analog uplink signal from UE 201 is received by antenna 140 and processed by a receiver unit (RCVR) A 150 to obtain samples. The receiver unit A 150 conditions, for example, filters, amplifies and frequency downconverts the analog uplink signal to produce a second “conditioned” signal. The second “conditioned” signal is then sampled. The receiver unit A 150 is in communication with a symbol demodulator C 160. One skilled in the art will understand that an alternative is to implement the sampling process in the symbol demodulator C 160. The symbol demodulator C 160 performs data demodulation on the data symbols to obtain data symbol estimates on the uplink path and then provides the uplink pilot symbols and the data symbol estimates on the uplink path to the RX data processor A 170. The data symbol estimates on the uplink path are estimates of the data symbols that were transmitted. The RX data processor A 170 processes the data symbol estimates on the uplink path to recover the traffic data transmitted by the UE 201. The symbol demodulator C 160 is also in communication with processor A 180. Processor A 180 performs channel estimation for each active terminal transmitting on the uplink leg. Multiple terminals may transmit pilot symbols concurrently on the uplink leg on their respective assigned sets of pilot subbands where the pilot subband sets may be interlaced.

Processor A 180 and processor B 240 direct (i.e., control, coordinate or manage, etc.) operation at the access node 101 and at the UE 201, respectively. Either or both processor A 180 and processor B 240 may be associated with one or more memory units (not shown) for storing of program codes and/or data. Either or both processor A 180 or processor B 240 may perform computations to derive frequency and impulse response estimates for the uplink leg and downlink leg, respectively.

In some embodiments, the access node/UE system 100 may be a multiple-access system, such as FDMA, OFDMA, CDMA, TDMA, SDMA, etc. For a multiple-access system, multiple terminals transmit concurrently on the uplink leg, allowing access to a plurality of UEs. The pilot subbands may be shared among different terminals. Channel estimation techniques are used in cases where the pilot subbands for each terminal span the entire operating band (possibly except for the band edges). Such a pilot subband structure is desirable to obtain frequency diversity for each terminal

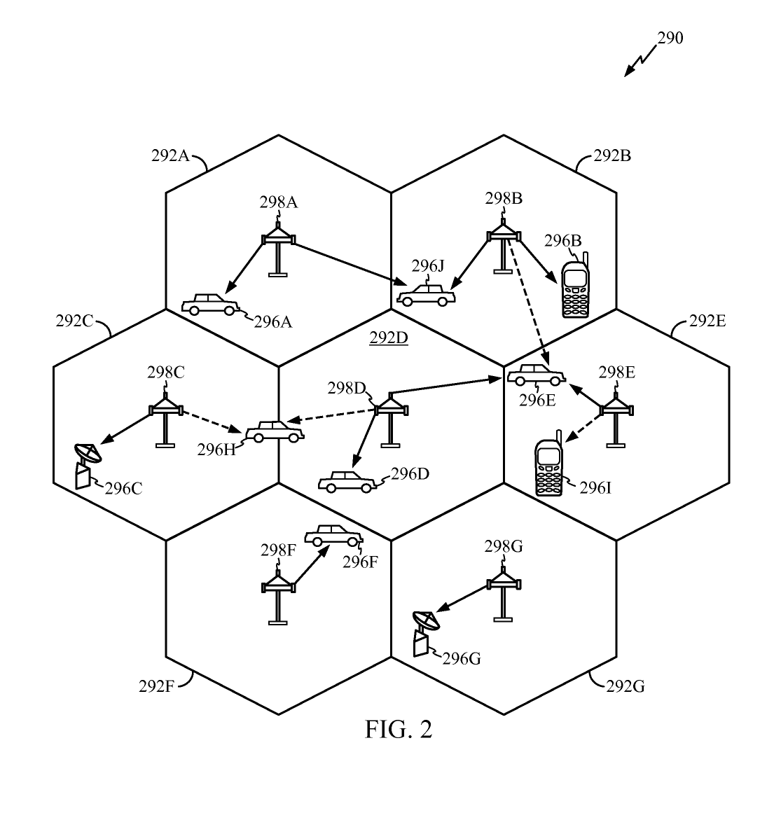

FIG. 2 illustrates an example of a wireless communications system 290 that supports a plurality of user devices. In FIG. 2, reference numerals 292A to 292G refer to cells, reference numerals 298A to 298G refer to base stations (BS) or NodeBs and reference numerals 296A to 296J refer to access user devices (a.k.a. UEs). Cell size may vary. Any of a variety of algorithms and methods may be used to schedule transmissions in system 290. System 290 provides communication for a number of cells 292A through 292G, each of which is serviced by a corresponding base station 298A through 298G, respectively.

When one of the mobile devices 296A to 296J moves to a different one of the cells 292A to 292G than the one from which it was previously being served, it begins to communicate with a new base station managing that cell (i.e., the corresponding one of the base stations 298A to 298G). This change in serving cell is referred to as a “handoff” (or, equivalently, “handoff”). The handoff may be performed while communicating with multiple base stations simultaneously before switching from a current base station to a neighboring base station, which is referred to as “soft handoff.” In soft handoff, communication with the neighboring base station may begin before communication with the current base station is terminated. There is a modified version of soft handoff called “softer handoff,” where the mobile device simultaneously communicates with a plurality of sectors within the same base station. Alternatively, a “hard handoff” may be performed when the change in serving cell is between two different frequencies or when a base station is not suitably synchronized for soft handoff. In hard handoff, communication with the current base station is terminated before communication with the neighboring base station is established.

As discussed in the background above, smaller cells are starting to be deployed to extend the coverage area or otherwise work in conjunction with larger, macro cells such as those illustrated in FIG. 2. In this way, wireless communication systems may include a mixed plurality of cells to provide coverage for mobile users. In general, a macro cell may be a cell with a nominal radius typically on the order of kilometers, while a small cell may be a cell with a nominal radius typically less than one kilometer. Small cells (e.g., femto cells or pico cells) are often deployed in wireless communication systems as “hotspots” to offload macro cell signaling. A hotspot may provide, for example, public wireless access to the Internet. Small cells are well-suited for serving nomadic mobile devices with relatively low mobility.

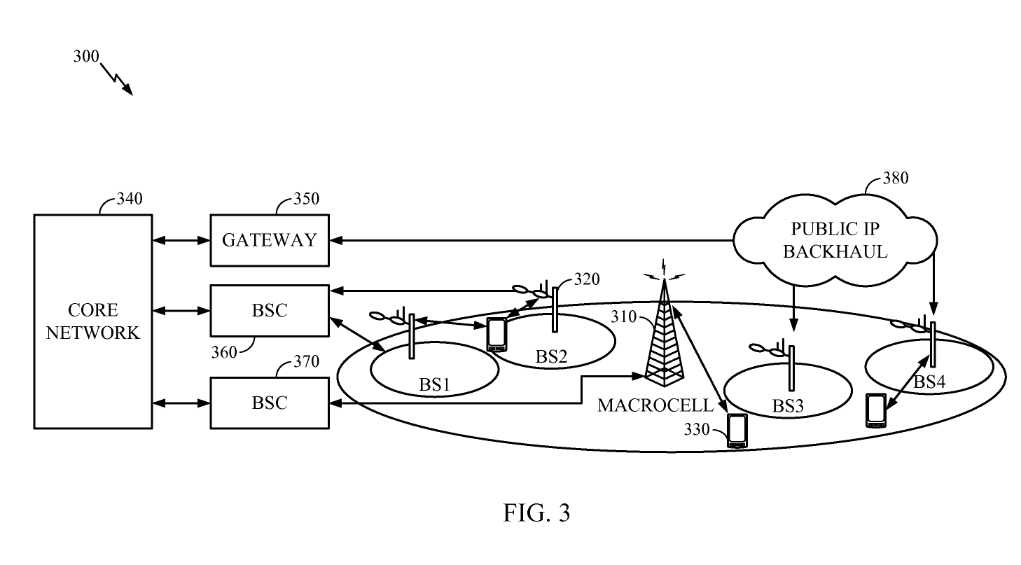

FIG. 3 illustrates an example communication system in which small cells are deployed in concert with macro cells. In this example, a network 300 includes a macro cell base station 310 deployed in concert with a plurality of small cell (e.g., femtonode or piconode) base stations 320. The small cell coverage areas may be identified by particular pseudo-random noise sequence offsets (PN offsets), primary scrambling codes (PSCs), or physical cell identifiers (PCIs), which may be reused among all or a portion of the small cell base stations 320. There are several deployment scenarios under which such a mixed-cell network 300 may be advantageous for providing service to a given mobile device 330, including, for example, remote locations (e.g., rural areas where there is limited macro cell coverage), coverage improvement (e.g., suburban areas at a macro cell edge), or capacity improvement (e.g., dense urban areas or hotspots).

As shown, the macro cell base station 310 is typically connected to a core network 340 via a macro cell base station controller (BSC) 360. However, there are several options for connecting the small cell base stations 320 to the core network 330. For example, some small cell base stations 320 may be connected to the core network 330 via a gateway 350 and a public IP backhaul link 380. A dedicated backhaul link may be required if soft handoff is supported for the small cell base stations 320, otherwise a public IP backhaul link may be sufficient. Other small cell base stations 320 may be connected to the core network 330 via a dedicated base station controller (BSC) 370.

The illustrated deployment model for the small cell base stations may be referred to as an open access small cell deployment model. Other models include a shared macro controller used in an outdoor network, and a dedicated controller used in an indoor network. One skilled in the art will appreciate, however, that these example models are not meant to be exhaustive and that other example models may be employed in certain systems.

There are several advantages in an open access small cell deployment model. For example, open selection of vendors is possible since inter-operability is only required at the core network, a simpler deployment is facilitated in remote locations with limited macro network coverage, simpler pseudo-random noise (PN) code assignments and neighbor list configuration, more backhaul options, etc. However, for small cells not controlled by a macro cell BSC, soft handoff may not be supported between small cells and macro cells, and registration may be required for idle transition between small cells and macro cells. In this case, handoff may be limited to hard handoff.

The lack of soft handoff, fast serving cell switching, and interference mitigation among small cells and macro cells in this type of system presents challenges for optimizing small cell performance. This is especially true at edge locations along the coverage boundary, where high velocity mobile devices may cause several problems as they attempt to switch cell coverage, and ongoing connections may be dropped.

Accordingly, apparatuses, methods, and other techniques are described herein for improving range tuning for open access small cells by leveraging mobile device information so as to not attract high velocity mobile devices or other devices with a high likelihood of handoff, while achieving a desired level of coverage. Various embodiments presented herein offer several advantages over conventional designs for improved usage of small cells in a wireless communication environment. The advantages disclosed herein are not exclusive, however, as other advantages may become apparent to one skilled in the art through the present disclosure.

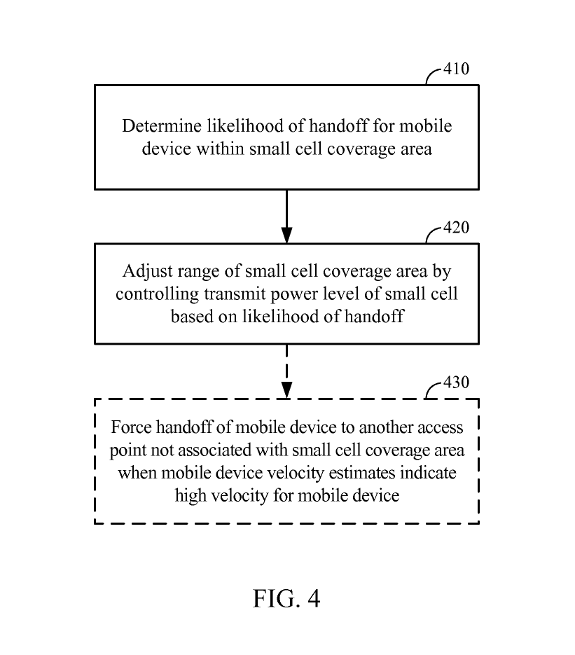

FIG. 4 illustrates an example method of range tuning for open access small cells. As shown, a small cell (e.g., one of the small cell base stations 320 illustrated in FIG. 3) may determine a likelihood of handoff for a mobile device (e.g., the associated or potentially associated mobile devices 330 illustrated in FIG. 3) around its small cell coverage area (block 410), and adjust a range of the small cell coverage area by controlling a transmit power level of the small cell based on the likelihood of handoff (block 420). As discussed above, the small cell coverage area to be adjusted may be identified by a pseudo-random noise sequence offset (PN offset) or primary scrambling code (PSC).

In this way, forward link (FL) or downlink (DL) transmit power, for example, may be calibrated to control the coverage radius of a small cell (e.g., to cover a corresponding hotspot area without attracting high mobility mobile devices). A calibration performed in this manner may avoid unnecessary handoffs and may limit channel element power consumption by excluding a high mobility coverage area, since a large number of high mobility mobile devices may trigger frequent hand-in and immediately hand-out situations. In such cases, handoff procedures may not be able to be performed quickly enough to ensure a successful handoff. Moreover, frequent handoffs generate more signaling load to other network elements.

In some embodiments, the small cell may comprise a femto cell or pico cell base station (e.g., one of the small cell base stations 320 illustrated in FIG. 3) not controlled by a macro cell base station controller (e.g., the macro cell BSC 370). Instead, the small cell may operate independently from the macro cell network, and communicate with a core network (e.g., the core network 340) via either a gateway and backhaul link (e.g., the gateway 350 and the public IP backhaul link 380) or a dedicated BSC (e.g., the dedicated BSC 370). The likelihood of handoff may accordingly correspond to an expected frequency of handoffs from the femto cell or pico cell base station to a macro cell base station controlled by the macro cell base station controller, with such handoffs leading to the associated problems discussed above.

According to various embodiments, the likelihood of handoff may be determined in different ways. For example, in some embodiments, the likelihood of handoff may be determined based on a connection time duration of active mobile devices within the small cell, or, more generally, a history of connection time durations that each mobile spent in previous cells (e.g., from a UE History Information IE in the UTRAN Iu interface). A short duration (e.g., on the order of tens of seconds) may indicate a high likelihood of handoff, and cause the coverage area to be contracted. Conversely, a large duration (e.g., on the order of several minutes) may indicate a low likelihood of handoff, and, in some instances, signal that the coverage area may be safely expanded.

In other embodiments, the likelihood of handoff may be determined based on handoff success/failure statistics. A high failure rate (e.g., greater than about 1%) may indicate that the coverage area should be contracted. Conversely, a high success rate (e.g., greater than about 99.99%) may indicate that the coverage area may be safely expanded.

In other embodiments, the likelihood of handoff may be determined based on a number of ping-pong handoffs between adjacent cells or a ratio of the number of ping-pong handoffs to the number of non-ping-pong handoffs in a cell. Generally, ping-pong handoffs may be recognized when a mobile device changes back and forth between adjacent cells more than once within a short period of time (e.g., a few seconds). The information about ping-pong handoffs may be obtained from the PL/RSCP measurements or UE connections or UE History Information IE, which is typically passed between cells during handoffs. This IE contains information on the cells (e.g., up to 16) that a mobile device has been served by in active state prior to the target cell. For each of these cells, the IE contains cell identity, cell type (e.g., very small, small, medium, large, macro, femto, etc.) and the time mobile device stayed in that cell. Having obtained this history information, the number of ping-pong handoffs performed by the mobile device may be determined based, for example, on the average time spent by mobile devices on adjacent cells and/or the repetition of cell identities (for example, occurrence of at least once cell identity more than once). Handoffs between adjacent cells that are performed more than once and more frequently than a certain time threshold (e.g., a few seconds), may be considered to be ping-pong handoffs. The time threshold may be selected based on simulation, system requirements or other criteria. Occurrence of ping-pong handoffs indicates a high likelihood of handoff, and can cause the coverage area of a cell to be contracted. Conversely, absence of ping-pong handoffs may indicate a low likelihood of handoff, and the coverage area of the cell may be safely expanded.

In other embodiments, the likelihood of handoff may be determined based on the average time that mobile devices spend on the cell before switching to another cell. For example, when the average time that mobile devices are served by a cell decreases, the likelihood of handoff increases. The cell should preferably keep number of handoffs per unit time (for e.g., a minute) low to save signaling load, decrease packet delays, improve user experience and network load. To that end, the network may indicate the average time that mobile devices should spend on a cell before handoff. If the actual time that devices spend on the cell falls below this threshold, the cell should regulate (e.g., decrease) its transmit power in order to decrease the number of handoffs to adjacent cells and maximize the time that mobile devices spend on the cell before switching to the adjacent cells.

In other embodiments, the likelihood of handoff may be determined based on the number of call drops or connection failures in the cell. For example, as the number of call drops or connection failures in the cell increases, so is the likelihood of handoffs to another cell will increase as well. The network may indicate the maximum number of call drops or connection failures per unit time (for example, per minute) that a cell may have before it should shrink its coverage area to limit the number of mobile devices on that cell and to prevent access to the cell by fast moving mobile devices, which increase signaling load, consume limited radio resources and degrade overall user experience.

In other embodiments, the likelihood of handoff may be determined based on the number of access terminals served by the cell. For example, as the number of mobile devices served by the cell approaches cell's capacity, the throughput will degrade, and the likelihood of handoffs will also increase. The network may specify the maximum number of mobile devices that a small cell may serve at one time before is should regulate its transmit power in order to offload some of the mobile devices to other cells.

In other embodiments, the likelihood of handoff may be determined based on interference experienced by a mobile device at the cell. The interference may be measured as a Signal-to-Interference Ratio (SIR) or a Signal-to-Interference-plus-Noise Ratio (SINR) of the cell. The interference in a small cell should be kept to a minimum to decrease Bit Error Rate (BER), prevent retransmissions and increase network throughput. Generally, the greater is SINR in a cell, the lesser is the likelihood of handoff. The network may specify the minimum SINR that a cell may have before it should regulate its transmit power in order to expand or shrink its pilot pollution region.

In still other embodiments, the likelihood of handoff may be determined based on mobile device velocity estimates. High velocity estimates may indicate a high likelihood of handoff, and cause the coverage area to be contracted. Conversely, low velocity estimates may indicate a low likelihood of handoff, and, in some instances, signal that the coverage area may be safely expanded. It will be appreciated that what constitutes a high velocity may depend on the size of the particular coverage area at issue as well as other factors. For example, for a target connection duration of at least one minute and a cell diameter of approximately 100 meters, a speed greater than about 100 meters/minute may be considered a high velocity.

The mobile device velocity estimates may be based at least in part on periodic position reports from the mobile device, periodic velocity reports from the mobile device, Doppler estimates in the mobile device or base station, or a round trip delay measurement for communication with the mobile device, for example. When the mobile device velocity estimates indicate a high velocity for the mobile device, the small cell may, in some instances, force a handoff of the mobile device to another access point not associated with the small cell coverage area (illustrated by optional block 430 in FIG. 4).

In still other embodiments, the likelihood of handoff may be determined based on the number of hand-ins in a given time period or the number of hand-outs in a given time period. A high number of hand-ins or hand-outs in a given time period may indicate a high likelihood of handoff, and cause the coverage area to be contracted. Conversely, a low number of hand-ins or hand-outs in a given time period may indicate a low likelihood of handoff, and, in some instances, signal that the coverage area may be safely expanded. It will again be appreciated that what constitutes a high number of hand-ins or hand-outs may depend on the size of the particular coverage area at issue as well as other factors. For example, if a cell can serve 16 connected users simultaneously and a target connection duration is set to at least one minute, it may be desired that the number of handoffs be less than 16 handoffs per minute, with anything greater constituting a high number of hand-ins/hand-outs.

In addition or as an alternative to the techniques above, the likelihood of handoff may also be determined based on mobile-assisted information provided by the mobile device. Mobile-assisted range tuning for open access small cells may involve several options.

In some embodiments, the likelihood of handoff may be determined based on mobile-assisted information including statistics collected from the mobile device while idle, statistics obtained by paging the mobile device at a time period after registration, or periodic registration information obtained from the mobile device. For example, a small cell may page a mobile device at some time period after registration to see whether the mobile device is still within the small cell coverage area. The page may be performed in conjunction with a duration threshold used to make a decision on whether to decrease the small cell transmit power. In one example, the page may be sent only to a subset of the mobile devices that have registered with the small cell. In other examples, the small cell may configure the mobile device to perform periodic registration, where the period may be determined based on a duration threshold for adjusting the small cell transmit power.

It will be appreciated that two or more of the above methods for determining the likelihood of handoff for a given mobile device may be employed in concert.

When adjusting the range of the small cell coverage area, controlling the transmit power level of the small cell may be constrained by a configurable maximum target limit (Txmax) and a configurable minimum target limit (Txmin) derived from a transmission power or a measured received power of a neighboring macro cell. For example, the open access small cell transmit power may be increased or decreased up to a certain limit determined based on a macro cell pilot strength, where the limit may be determined to meet a target maximum coverage area and a target minimum coverage area (e.g., between about an 80 dB and about a 110 dB pathloss). The adjustment may be event based, for example, such as every time a threshold is crossed, or periodic, where the increase/decrease is based on the aggregate statistics of all events in a given period. In some instances, the increased transmit power may be smaller in magnitude and more infrequent, while the decreased transmit power may be larger in magnitude and more immediate.

One skilled in the art will understand that certain steps disclosed in the example flow diagram in FIG. 4 can be interchanged in their order without departing from the scope and spirit of the present disclosure. Also, one skilled in the art will understand that the steps illustrated in the flow diagram are not exclusive and that other steps may be included or one or more of the steps in the example flow diagram may be deleted without affecting the scope and spirit of the present disclosure.

Methods for improving range tuning for open access small cells by leveraging mobile device information as provided herein may be implemented by a device configured as a communication device or as a processor or similar device for use within the communication device. For example, the device may include functional blocks representing functions implemented by a processor, software, hardware or a combination thereof (e.g., firmware), and may include one or more electrical components for performing the steps illustrated in blocks 410-430.

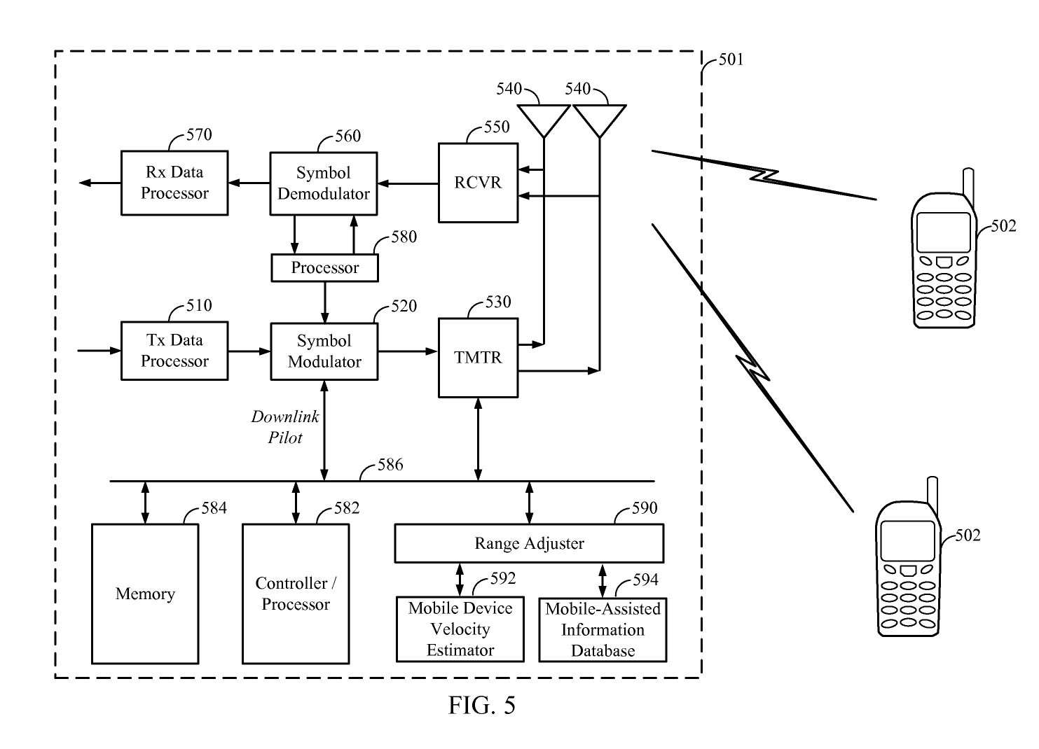

FIG. 5 illustrates an example small cell base station apparatus configured to perform range tuning according to one or more of the embodiments described above. As with the access node 101 illustrated in FIG. 1, the small cell base station apparatus 501 includes a corresponding TX data processor 510, symbol modulator 520, transmitter unit (TMTR) 530, antenna(s) 540, receiver unit (RCVR) 550, symbol demodulator 560, RX data processor 570, and configuration information processor 580, performing the operations described above for communicating with one or more mobile devices 502. The small cell base station apparatus 501 may also include one or more general purpose controllers or processors (illustrated in the singular as the controller/processor 582) and memory 584 configured to store related data or instructions. Together, via a bus 586, these units may perform processing in accordance with the appropriate radio technology or technologies used for communication, as well as other functions for the small cell base station apparatus 501.

According to various embodiments, the small cell base station apparatus 501 may further include a range adjustment module 590 for determining a likelihood of handoff for a mobile device around the small cell coverage area and for adjusting a range of the small cell coverage area accordingly, by controlling a transmit power level of the small cell base station apparatus 501 based on the likelihood of handoff. As shown, the range adjustment module 590 may make the determination and adjustment based on information provided by other specially purposed modules, such as the illustrated mobile device velocity estimator 592 and/or the mobile-assisted information database 594. It will be appreciated that, in some designs, the functionality of one or more of the range adjustment module 590, the mobile device velocity estimator 592, or the mobile-assisted information database 594 may be integrated directly into, or otherwise performed by, the general purpose controller/processor 582 of the small cell base station apparatus 501, sometimes in conjunction with the memory 584.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit.

Additionally, the various illustrative flow diagrams, logical blocks, modules and/or algorithm steps described herein may also be coded as computer-readable instructions carried on any computer-readable medium known in the art or implemented in any computer program product known in the art. Computer-readable media include both computer storage media and communication media including any medium that facilitates transfer of a computer program from one place to another. A storage medium may be any available medium that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of a medium. Disk and disc, as used herein, include compact disc (CD), laser disc, optical disc, digital versatile disc (DVD), floppy disk and blu-ray disc, where disks usually reproduce data magnetically, and discs reproduce data optically with lasers. Combinations of the above should also be included within the scope of computer-readable media.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method of range tuning for open access small cells, comprising:
determining a likelihood of handoff for a mobile device around a small cell coverage area; and
adjusting a range of the small cell coverage area by controlling a transmit power level of the small cell based on the likelihood of handoff.

2. The method of claim 1, wherein the likelihood of handoff is determined based on a number of ping-pong handoffs between adjacent cells.

3. The method of claim 1, wherein the likelihood of handoff is determined based on a ratio of ping-pong handoffs to non-ping-pong handoffs between adjacent cells.

4. The method of claim 1, wherein the likelihood of handoff is determined based on the time spent by a mobile device on the cell.

5. The method of claim 1, wherein the likelihood of handoff is determined based on the number of mobile devices served by the cell.

6. The method of claim 1, wherein the likelihood of handoff is determined based on a number of connection failures in the cell.

7. The method of claim 1 wherein the likelihood of handoff is determined based on interference experienced by at least one mobile device at the cell.

8. The method of claim 7, wherein the at least one interference metric is based on at least one of a Signal-to-Interference-Ratio (SIR) of the cell and Signal-to-Interference-plus-Noise Ratio (SINR) of the cell.

9. An apparatus for range tuning for open access small cells, comprising:
at least one processor configured to determine a likelihood of handoff for a mobile device around a small cell coverage area, and to adjust a range of the small cell coverage area by controlling a transmit power level of the small cell based on the likelihood of handoff; and
memory coupled to the at least one processor and configured to store related data and/or instructions.

10. The apparatus of claim 9, wherein the likelihood of handoff is determined based on a number of ping-pong handoffs between adjacent cells.

11. The apparatus of claim 9, wherein the likelihood of handoff is determined based on a ratio of ping-pong handoffs to non-ping-pong handoffs between adjacent cells.

12. The apparatus of claim 9, wherein the likelihood of handoff is determined based on the time spent by a mobile device on the cell.

13. The apparatus of claim 9, wherein the likelihood of handoff is determined based on the number of mobile devices served by the cell.

14. The apparatus of claim 9, wherein the likelihood of handoff is determined based on a number of connection failures in the cell.

15. The apparatus of claim 9, wherein the likelihood of handoff is determined based on interference experienced by at least one mobile device at the cell.

16. The apparatus of claim 15, wherein the at least one interference metric is based on at least one of a Signal-to-Interference Ratio (SIR) of the cell and a Signal-to-Interference-plus-Noise Ratio (SINR) of the cell.

17. A non-transitory computer-readable medium comprising code, which, when executed by at least one processor, causes the at least one processor to perform operations for range tuning for open access small cells, the non-transitory computer-readable medium comprising:
code for determining a likelihood of handoff for a mobile device around a small cell coverage area; and
code for adjusting a range of the small cell coverage area by controlling a transmit power level of the small cell based on the likelihood of handoff.

18. The non-transitory computer-readable medium of claim 17, wherein the likelihood of handoff is determined based on a number of ping-pong handoffs between adjacent cells.

19. The non-transitory computer-readable medium of claim 17, wherein the likelihood of handoff is determined based on a ratio of ping-pong handoffs to non-ping-pong handoffs between adjacent cells.

20. The non-transitory computer-readable medium of claim 17, wherein the likelihood of handoff is determined based on the time spent by a mobile device on the cell.

21. The non-transitory computer-readable medium of claim 17, wherein the likelihood of handoff is determined based on the number of mobile devices served by the cell.

22. The non-transitory computer-readable medium of claim 17, wherein the likelihood of handoff is determined based on a number of connection failures in the cell.

23. The non-transitory computer-readable medium of claim 17, wherein the likelihood of handoff is determined based on interference experienced by at least one mobile device at the cell.

24. The non-transitory computer-readable medium of claim 23, wherein the at least one interference metric is based on at least one of a Signal-to-Interference-Ratio (SIR) of the cell and a Signal-to-Interference-plus-Noise Ratio (SINR) of the cell.
